(19) United States
(12) Patent Application Publication
(10) Pub. No.: US 2011/0283048 A1
(43) Pub. Date: Nov. 17, 2011

(54) STRUCTURED MAPPING SYSTEM FOR A MEMORY DEVICE

(75) Inventors: Timothy R. Feldman, Louisville, CO (US); Brett A. Cook, Longmont, CO (US); Jonathan W. Haines, Boulder, CO (US); Wayne H. Vinson, Longmont, CO (US)

(73) Assignee: SEAGATE TECHNOLOGY LLC, Scotts Valley, CA (US)

(21) Appl. No.: 12/777,923

(22) Filed: May 11, 2010

(51) Int. Cl. G06F 12/10; G06F 12/02; G06F 12/00

(52) U.S. Cl. 711/103; 711/202; 711/206; 711/E12.001; 711/E12.059; 711/E12.008

(57) ABSTRACT

This disclosure is related to systems and methods for a structured mapping system for a memory device, such as a solid state data storage device. In one example, a data storage device may include a multi-level address mapping system. The multi-level address mapping system may be implemented completely independent of a host computer and a host computer operating system. Also, the multi-level mapping system may be stored to allow each level, or subsets of each level, to be re-written independently of the other levels or the other subsets.

### BACKGROUND

Some file systems force certain areas, such as where file-system tables are kept, to be rewritten very frequently. In a solid state data storage device, such as a Flash memory device, the rewriting may generate extra wear which may reduce reliability and performance. In addition, multi-level cell (MLC) Flash memory is less tolerant of wear and has a slower access time than single level cell Flash memory and may encounter even greater problems if it is storing frequently written file-system tables. Thus, a new system that addresses at least these issues is needed.

### SUMMARY

In one embodiment, a data storage device may include a multi-level address mapping system. The multi-level address mapping system may be implemented completely independent of a host computer and a host computer operating system. Also, the multi-level mapping system may be stored to allow each level, or subsets of each level, to be re-written independently of the other levels or the other subsets.

In another embodiment, a device may comprise a non-volatile data storage medium, an interface to receive commands and data from a host computer, and a control circuit coupled to the interface and data storage medium. The control circuit may be adapted to implement a multi-level address mapping system within the device and independent of the host computer.

In yet another embodiment, a device may comprise a control circuit adapted to implement a multi-level address mapping system within a data storage device and independent of any host computer. The control circuit may be adapted to determine a first pointer from a first level of the multi-level address mapping system, where the first pointer indicates a portion of a second level of the multi-level address mapping system. The control circuit may also be adapted to determine a second pointer from the second level, where the second pointer indicates a portion of a third level of the multi-level address mapping system. The control circuit may also be adapted to determine a third pointer from the third level, where the third pointer indicates a physical location of a logical block address.

### BRIEF DESCRIPTION OF THE DRAWINGS

FIG. 1 is a diagram of an illustrative embodiment of a system having a structured mapping system for a memory device;

FIG. 2 is a diagram of an illustrative embodiment of a structured mapping system for a memory device;

FIG. 3 is a diagram of another illustrative embodiment of a structured mapping system for a memory device; and

FIG. 4 is a diagram of another illustrative embodiment of a structured mapping system for a memory device.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

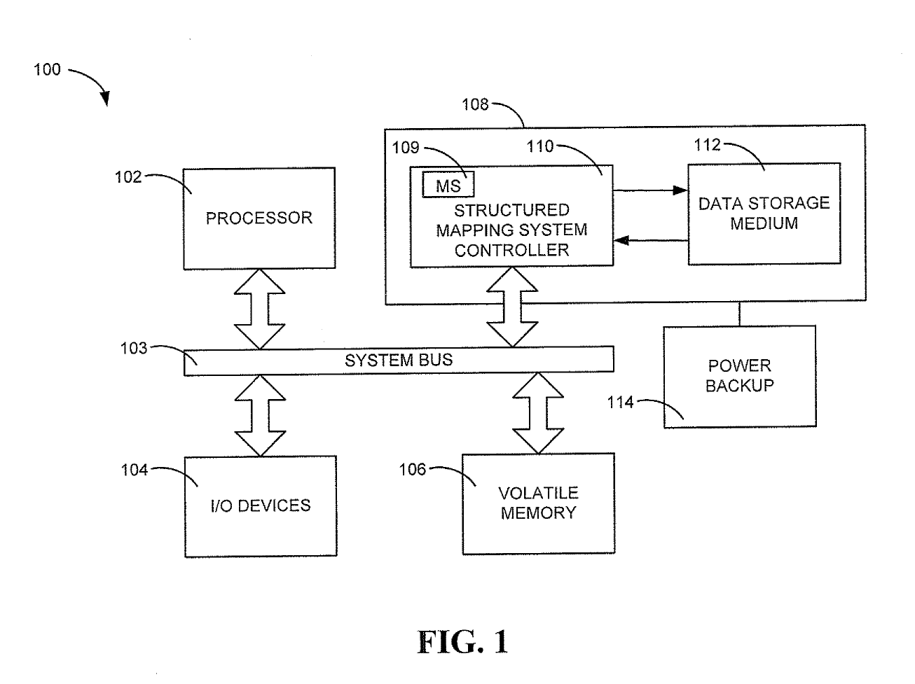

Referring to FIG. 1, a particular embodiment of a system having a structured mapping system for a memory device is shown and generally designated 100. The system 100 may include a processor 102 connected to a system bus 103 which also can be connected to input/output (I/O) devices 104, such as a keyboard, monitor, modem, storage device, or pointing device. The system bus 103 may also be coupled to a memory 106, which may be a random access volatile memory, such as dynamic random access memory (DRAM). The system bus may also be coupled to a data storage device 108. In a particular embodiment, the data storage device 108 comprises a solid state data storage device. In another particular embodiment, the data storage device 108 comprises a non-volatile Flash memory device. In yet another embodiment, the data storage device comprises a disc drive.

The data storage device 108 may include a controller 110, which may be coupled to the processor 102 via a connection through the system bus 103. The controller 110 may include a mapping system module 109 adapted to implement a structured mapping system. The data storage device 108 may also contain data storage medium 112, such as an array of data storage cells. The data storage medium 112 may include one or more integrated circuit memory chips. For example, the data storage cells 112 may be Multi-Level Cell (MLC) NAND non-volatile Flash memory or Single-Level Cell (SLC) NAND non-volatile Flash memory.

The data storage device 108 may communicate with the processor 102 via an interface (not shown) adapted to receive commands and data from the processor 102. Further, the data storage device 108 may be configured to implement a structured mapping system via the controller 110 independent of the processor 102 or any other hardware or function of the system 100. In a particular embodiment, in addition to implementing and managing the structured mapping system, the controller 110 may also be a data storage controller.

The data storage device 108 may be connected to a power backup 114 which may be a secondary power source, such as a battery, rechargeable capacitor, or any other energy store. The power backup 114 may be located internal or external to the data storage device 108. The power backup 114 can provide power to ensure that if a power supply to the data storage device 108 is lost, there will be enough power to write a deterministic amount of data to the data storage medium 112. As long as the data storage device 108 has sufficient cache memory space (not shown) and the power backup 114 is available, the data storage device 108 can save data in the cache until a sufficient amount has been acquired to fill (at least mostly) a whole page or whole pages. This can help reduce write amplification problems. Since each write to the data storage medium 112 of the smallest mapping unit contains a log entry indicating what was written therein, the mapping system can be viewed as a set of H parallel page-writing engines that write pages sequentially within page groups. Each set must keep track of the next page (EB Group, EB, page) to be written and may have a minimal-mapping-unit-sized cache (not shown) assigned to it. With a sufficient energy store and cache, parallelism can be beneficial to allow a larger set of data to be written or read in the same time that a unit without parallelism would read or write a smaller set of data.

During operation, the processor 102 may send a command to the memory device 108 to retrieve or store data. The controller 110 can receive the command from the processor 102 and determine a location of data corresponding to data relevant to the command via the mapping system module 109.

The mapping system module 109 may implement the structured mapping system, which determines a physical address location from a logical block address (LBA). Generally, the structured mapping system can be multi-level, which may consist of multiple address look-up tables. The address look-up tables may each contain information, such as pointers, to a location of a physical address or another table. Different levels of tables may be implemented to only allow a specific range of address information, such as a specific one of multiple tables, to be loaded into a cache. Each level of the structured mapping system may comprise multiple tables, each of the multiple tables may contain address information regarding a specific range of LBAs.

The structured mapping system may be implemented by a controller, dedicated hardware circuit, or any combination thereof. The structured mapping system may be implemented independent of a host computer, such that the host computer may be unaware that the structured mapping system is being used within the data storage device. The multiple tables of the structured mapping system may stored independently to allow each of the multiple levels to be re-written independently, or each table within a level to be re-written independently. The tables may be stored near user data on a non-volatile data storage medium within the data storage device, such as within one page of an erasure block where the rest of the pages in the erasure block are for user data.

The levels of the structured mapping system may be determined based on groupings of LBAs. In one example, the LBA grouping could be LBA per Page to map physical page addresses. However, the LBA grouping could be more sophisticated, such as a striping of data across multiple flash channels, a hash of the LBA values, or a logical erasure block per physical erasure block (EB) number.

A mapping unit (such as LBA grouping per Page) can be any arbitrarily sized unit. However, since NAND flash is page-programmable and EB-erasurable, mapping objects between page-sized and EB-sized units is preferable. For example, when an EB is erased, all units therein go from a garbage state to an erased state, thus there is some efficiency to have an integer number of mapping units equal to an EB. Also, when a particular number of pages are programmed, a mapping entry must also be altered, and this scheme would allow less formatting loss due to metadata requirements by tracking only down to the page level.

In some embodiments, many levels of mapping may be implemented. For example, from the resolution of an integer number of pages to an integer number of EBs.

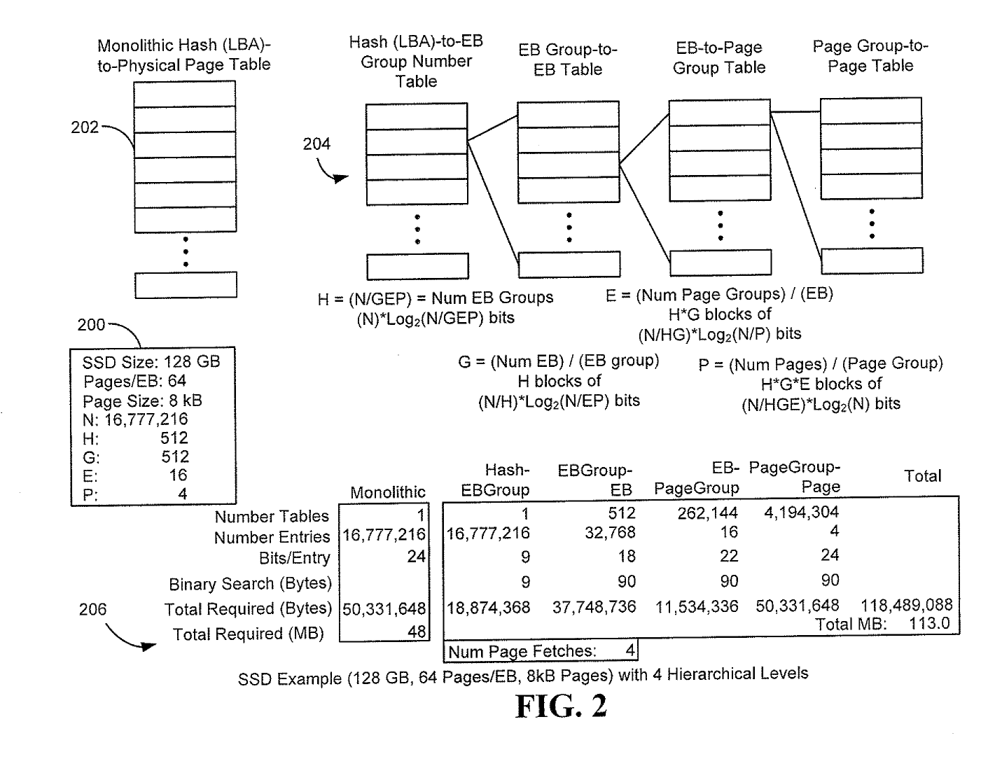

FIG. 2 shows a diagram of an illustrative embodiment of a structured mapping system for a memory device, and also includes a comparison between a monolithic mapping approach and a structured mapping system with four (4) hierarchical levels. The example of FIG. 2 compares a structure of a monolithic mapping table 202 to a hierarchical mapping system 204 for a particular data storage device 200. However, any type or size of data storage device that implements a LBA mapping system may be used.

As can be seen via the comparison tables 206, the hierarchical mapping system 204 uses more storage space than the monolithic mapping table 202. However, the hierarchical mapping system 204 can store much of the mapping data directly to the data storage medium which stores the associated data, such as data storage medium 112, and fetch it only on an as-needed basis. Whereas, the monolithic mapping table 202 would be stored in a higher-cost cache memory. The hierarchical mapping system 204 reduces the amount of mapping data that needs to be stored in a higher-cost cache memory because the lowest-layer metadata can be written alongside the user data in every page (or group of pages). Also, periodic updates could be made to the higher level tables to make power-on-recovery times very manageable. By performing binary searches for data in the hierarchical tables, the number of table fetches can be significantly limited.

As shown in FIG. 2, the mapping system may be a log-structured (i.e. hierarchical) mapping system. In the mapping system, a highest-level table(s), such as Hash-to-EBGroup table(s), may be stored in cache memory. The term “highest” indicates that this is the first level of table(s) accessed to navigate the mapping system. In the example of FIG. 2, the mapping system determines an EB Group pointer from the first level of table(s), the Hash-to-EB Group Table(s), based on a specific LBA. The mapping system then retrieves a specific table from the second level table(s), the EB Group-to-EB table(s), that is indicated by the EB Group pointer.

Then, the mapping system determines an EB pointer from the retrieved second level table and retrieves another specific table from the third level of table(s), the EB-to-Page Group table(s), that is indicated by the EB pointer. The mapping system then determines a Page Group pointer from the retrieved third level table and retrieves another specific table from the fourth level of table(s), the Page Group-to-Page table(s), that is indicated by the Page Group pointer. The mapping system can then use the retrieved fourth level table to determine a specific physical address of the page associated with the specific LBA. Also, in the example of FIG. 2, the fourth level table(s) may also be referred to as the “lowest” level tables, indicating that it is the table(s) that store physical address information.

All of the second, third, and fourth level table(s) would not need to be stored in cache, as only the tables indicated by the pointers would need to be retrieved from the data storage medium and loaded into a cache. The second, third, and fourth level tables could be stored on the data storage medium or elsewhere. All of the pointers may be determined based on an LBA associated with specific data to be stored or retrieved.

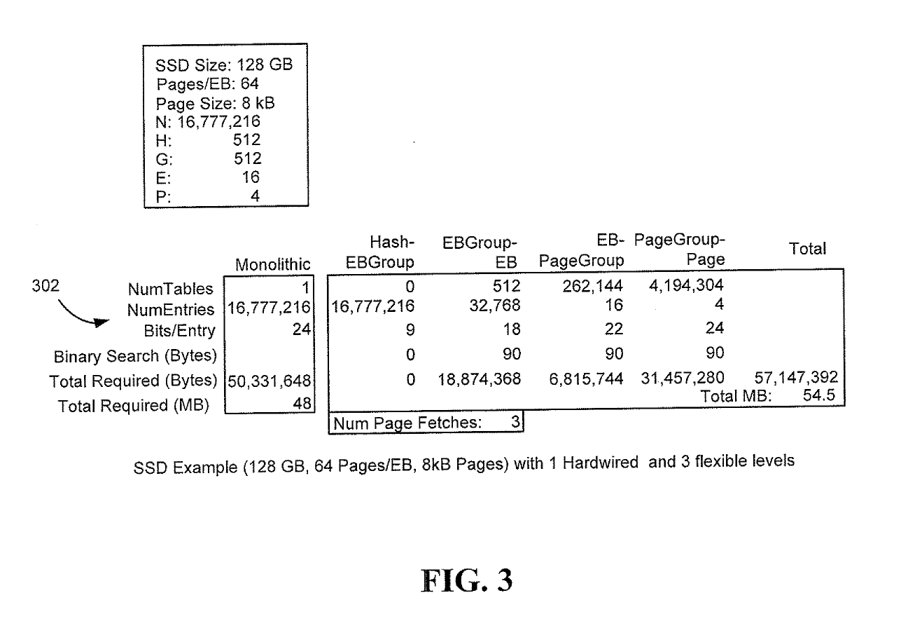

FIG. 3 shows a diagram of an illustrative embodiment of a structured mapping system for a memory device, and also includes a comparison table 302 between a monolithic mapping approach and a structured mapping system with four (4) hierarchical levels. Further, the embodiment described in FIG. 3 includes the first level table(s) hardwired to an algorithm making them non-flexible (i.e. not updateable or changeable). A hardwired mapping may comprise a dedicated electronic circuit configured to implement an algorithm to produce an arithmetic computation to determine a mapping to a next level. The algorithm may be implemented via software or hardware circuit(s). In such an example, the amount of memory required for the highest-level table is further reduced compared to the monolithic mapping. In the particular embodiment, the highest-level does not need tables as the algorithm will determine the EB Group pointer via arithmetic computation. Further, the number of bits to store the other level tables is reduced, since all locational references only need to be unique within the subarray. In the particular example of FIG. 3, the mapping of the pointers for the 512 highest-level groups is arithmetically hardwired.

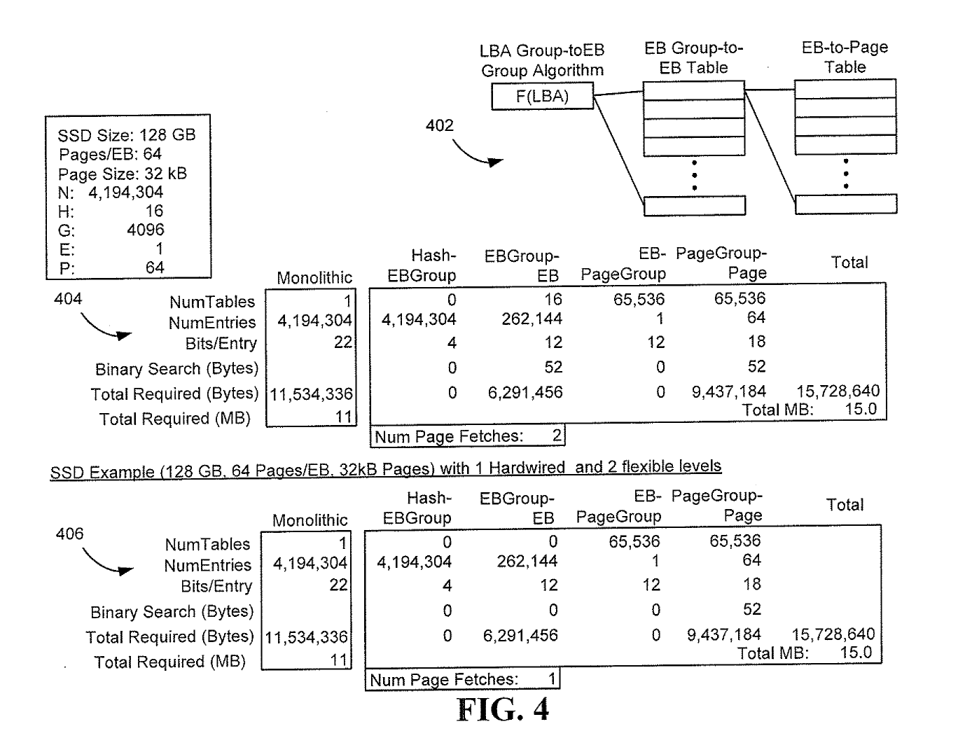

FIG. 4 shows a diagram of another illustrative embodiment of a structured mapping system 402 for a memory device, and also includes a comparison between a monolithic mapping approach and a structured mapping system with a hard-wired first-level mapping and 2 flexible mapping levels.

In a particular embodiment shown, the first comparison table 404 shows a mapping system that includes a hard-wired first-level, Hash(LBA Group)-EBGroup, and two flexible mapping levels, EBGroup-EB and EB-Page. The hard-wired first-level can be implemented as an algorithm that ties the first-level mapping to 16 ED Groups of the second level. Also, for example, if a 4× coupling (e.g. four pages coupled together) is also applied, then the metadata for the same sized data storage device as shown in FIG. 2 would need about ⅓ the storage space for the metadata of the configuration shown in the first comparison table 404. Effectively hard-wiring two levels of the mapping system can reduce time spent fetching the hierarchical tables because only 2 page fetches would be necessary to determine the physical page location for a read to proceed to the desired page.

In another particular embodiment, the second comparison table 406 shows a mapping system that includes a hard-wired first-level, Hash(LBA Group)-EBGroup, and two flexible mapping levels, EBGroup-EB and EB-Page. The particular embodiment shown in the comparison table 406 includes the EBGroup-EB mapping table(s) loaded into cache memory. This allows the mapping system to only need one table/page fetch per read to determine a physical page location for a desired page.

During writes, the data storage system may cache a page worth of data before writing a physical page worth of data, such that each page written is completely written with data. When a number of pages (63 for example) that is one less than the number of pages in an EB (64 for example) is written, an EB may be considered full and a PageGroup (for example, an EB in the FIG.4 configurations) table can be written to the final page (for example, the 64^{th} page) of the EB. In one embodiment, each time an EB fills, an EB can also be erased (on average). This may be done sequentially or concurrently. Using the example of FIG. 4, for each 262,144 EBs written, a corresponding EBGroup table may be re-written. The EBGroup table may be re-written more often; for example, to limit power-on state recovery delays.

In another particular embodiment, the page-writing engines can be duplicated for concurrent gains. For example, striping can allow multi-sector reads to perform nearly as quickly as single-sector reads, as long as the striping causes concurrent LBA reads from other independent flash channels. Further performance improvement may be gained by implementing command queuing.

In yet another particular embodiment, a hierarchical mapping system may have two levels, a hard-wired first level and a flexible mapping second level. For example, the hard-wired first level may divide LBAs into specific groups and the flexible mapping second level may map an LBA to a final physical location. The mapping of the second level may be based on a logical mapping unit granularity, such as a page.

In particular embodiments, the above discussed systems are implemented via an application specific integrated circuit (ASIC) that is configured to automate the table fetching and traversal. The systems and methods disclosed herein provide benefits over a log-structured file system implemented at an operating system of a host and a monolithic system where a single monolithic map is stored in cache memory. For example, a single monolithic map can be stored in cache memory, however, a power-on state recovery delay and/or the steps taken to become power-removal safe may take a certain amount of time to process. The systems and methods disclosed herein can reduce the amount of time to process a mapping system during a power-on state recovery delay or during a process to allow a safe power-removal.

It is to be understood that even though numerous characteristics and advantages of various embodiments have been set forth in the foregoing description, together with details of the structure and function of the various embodiments, this disclosure is illustrative only, and changes may be made in detail, especially in matters of structure and arrangement of parts. For example, the embodiments described herein can be implemented for any type of data storage device that uses logical block addresses, such as solid state memory devices, disc drives, or hybrid data storage devices. Further, the methods describe herein may be implemented by a computer processor, controller, hardware circuits, or any combination thereof. Also, the particular elements may vary depending on the particular application for the data storage system while maintaining substantially the same functionality without departing from the scope and spirit of the present disclosure. In addition, although an embodiment described herein is directed to a solid state data storage system, it will be appreciated by those skilled in the art that the teachings of the present application can be applied to any type of data storage device or computer system that may benefit from the ideas, structure, or functionality disclosed herein.

What is claimed is:

1. A device comprising:
a control circuit adapted to implement a multi-level address mapping system within a data storage device.

2. The device of claim 1 further comprising:
a data storage medium coupled to the control circuit; and
an interface coupled to the control circuit to receive commands and data from a host computer;
wherein the device implements the multi-level address mapping system independent of the host computer.

3. The device of claim 1 further comprising:
wherein the multi-level address mapping system comprises multiple tables; and
wherein address mapping comprises determining a physical location of a data storage medium from a logical block address.

4. The device of claim 1 further comprising the control circuit comprising a controller.

5. The device of claim 1 further comprising the control circuit comprising an application specific integrated circuit (ASIC), wherein at least one of the levels comprises a dedicated circuit within the ASIC configured to implement an algorithm.

6. The device of claim 1 further comprising the multi-level address mapping system comprising:
a first level adapted to relate a logical block address to a first grouping of addresses;
a second level adapted to relate the first grouping of addresses to a second grouping of addresses;
a third level adapted to relate the second grouping of addresses to a third grouping of addresses; and
a fourth level adapted to relate to the third grouping of addresses to particular physical data locations.

7. The device of claim 6 further comprising:
the first grouping of addresses comprising a table that lists a set of erasure block groups;
the second grouping of addresses comprising a table that lists a set of erasure blocks;
the third grouping of addresses comprising a table that lists a set of page groups; and
the fourth grouping of addresses comprising a table that lists a set of pages.

8. The device of claim 1 wherein the multiple levels of the multi-level mapping system are stored independently to allow each of the multiple levels to be re-written independently.

9. The device of claim 8, wherein the multiple levels and user data are stored on a non-volatile data storage medium within the data storage device.

10. The device of claim 1 further comprising the multi-level mapping system comprising:
at least one level comprising a hardwired mapping; and
at least one other level comprising a table,
wherein each hardwired mapping comprises a dedicated electronic circuit configured to implement an algorithm to produce an arithmetic computation to determine a mapping to a next level.

11. The device of claim 10 further comprising at least two levels comprising hardwired mappings.

12. The device of claim 10 further comprising at least two levels comprising tables

13. A device comprising:
a non-volatile data storage medium;
an interface to receive commands and data from a host computer;
a control circuit coupled to the interface and data storage medium and adapted to implement a multi-level address mapping system within the device and independent of the host computer.

14. The device of claim 13 wherein the commands received from the host computer include a logical block address to store associated data, the control circuit further comprises a data storage controller adapted to implement command queuing, and the data storage medium comprises a solid state data storage medium.

15. The device of claim 13 further comprising the multi-level address mapping system comprising at least one hardwired level and at least one flexible level, wherein a level comprises a range of physical addresses divided into multiple groupings.

16. The device of claim 15 further comprising multiple hardwired levels, wherein each hardwired level comprises a circuit configured to determine a pointer to a next level via an algorithmic computation.

17. The device of claim 15 further comprising multiple flexible levels, wherein each flexible level comprises multiple tables, wherein a table from a flexible level is loaded into a cache memory and parsed to determine a pointer to a next level.

18. The device of claim 17 further comprising a volatile cache memory, wherein a first flexible level is loaded into the volatile cache memory and a second flexible level is stored in the non-volatile data storage medium.

19. The device of claim 18 further comprising the second flexible level comprising tables indicating a physical location corresponding to an associated logical block address.

20. The device of claim 15, wherein the multiple groupings for a flexible level comprises data stored in tables physically proximate to data corresponding to the range of addresses in each table.

21. The device of claim 20 wherein the data storage medium is a solid state, page-based data storage device and wherein physically proximate comprises a table stored in a specific erasure block that also stores data corresponding to a range of addresses in the table.

22. A device comprising:
a control circuit adapted to implement a multi-level address mapping system within a data storage device and independent of any host computer, the control circuit adapted to:
determine a first pointer from a first level of the multi-level address mapping system, the first pointer indicating a relationship to a second level of the multi-level address mapping system; and
determine a second pointer from the second level based on the relationship to the first pointer, the second pointer indicating a physical location of a data location.

23. The device of claim 22, wherein at least one level of the multi-level address mapping system comprises a hardwired level and another level of the multi-level address mapping system comprises at least one table containing pointers, wherein a hardwired level comprises a dedicated circuit configured to determine a pointer based on a computation.

24. The device of claim 23 further comprising:
a non-volatile data storage medium coupled to the control circuit;
a cache memory coupled to the control circuit;
an interface coupled to the control circuit to receive commands and data from a host computer; and
at least one of the levels of the multi-level address mapping system comprises multiple tables;
wherein a single table from a level comprising multiple tables is loaded into the cache memory and parsed to determine a pointer.

25. The device of claim 24 further comprising:
a first level comprising a hard-wired level to determine a first pointer to a second level;
the second level is a flexible level comprising multiple tables and the first pointer indicates a specific table of the second level and the specific table in the second level includes a second pointer to a third level; and
the third level indicates a physical location on the non-volatile data storage medium associated with a particular logical block address;
wherein each of the multiple tables associated with each flexible level can be re-written independently.
